(19) United States
(12) Patent Application Publication
(10) Pub. No.: US 2002/0086079 A1
(43) Pub. Date: Jul. 4, 2002

(54) Lipstick making mold having vacuuming removing device

(76) Inventor: Fu Chin Kuo, Tainai Hsien (TW)

Correspondence Address: Charles E. Baxley, 59 John Street - 5th Floor, New York, NY, 10038, US

(21) Appl. No.: 09/751,073

(22) Filed: Jan. 2, 2001

(51) Int. Cl. B29C 39/36

(52) U.S. Cl. 425/405.1; 425/440; 249/103; 425/DIG. 44

(57) ABSTRACT

A lipstick making mold includes a base having one or more cavities for receiving one or more elastic mold pieces and for receiving the lipstick material. The elastic mold pieces have an outer diameter smaller than the inner diameter of the cavities of the base, for forming a peripheral gap between each elastic mold piece and the base. A vacuuming device may be used to vacuum the peripheral gap and to draw the elastic mold piece to engage with the base, for allowing the lipstick material to be easily and quickly removed from the elastic mold pieces.

### BACKGROUND OF THE INVENTION

1. Field of the Invention

The present invention relates to a lipstick making mold, and more particularly to a lipstick making mold having a vacuuming device for removing the lipstick from the mold piece.

2. Description of the Prior Art

The closest prior art of which the applicant is aware is his prior U.S. Pat. No. 6,022,209 to Kuo and comprises one or more actuators coupled to one or more mold pieces for expanding the mold pieces with the mechanical expanding facility that is complicated and may not be easily operated.

The present invention has arisen to mitigate and/or obviate the afore-described disadvantages of the conventional lipstick making devices.

### SUMMARY OF THE INVENTION

The primary objective of the present invention is to provide a lipstick making mold having a vacuuming device for easily and quickly removing the lipstick from the mold piece.

In accordance with one aspect of the invention, there is provided a lipstick making device comprising a base including at least one cavity formed therein, at least one elastic mold piece received in the cavity of the base for receiving a lipstick material, the elastic mold piece including an outer diameter smaller than an inner diameter of the cavity of the base, for defining a peripheral gap between the elastic mold piece and the base, and means for vacuuming the peripheral gap formed between the elastic mold piece and the base to draw the elastic mold piece to engage with the base and to facilitate a disengagement of the lipstick material from the elastic mold piece.

The base includes at least one orifice formed therein and communicating with the peripheral gap and the cavity of the base, the vacuuming means includes a vacuuming device coupled to the orifice of the base to vacuum the peripheral gap and the cavity of the base.

The base includes at least one peripheral groove formed around the cavity of the base, the elastic mold piece includes a peripheral flange extended radially outward therefrom and a peripheral skirt extended from an outer peripheral portion of the peripheral flange and engaged in the peripheral groove of the base.

The elastic mold piece includes a peripheral flange extended radially outward therefrom, the lipstick making device further includes means for securing the peripheral flange of the elastic mold piece to the base.

The securing means includes a cover plate engaged on the peripheral flange of the elastic mold piece and the base. The cover plate includes a peripheral depression formed therein for receiving the peripheral flange of the elastic mold piece.

The cover plate includes at least one opening formed therein, the securing means includes a cover board engaged on the cover plate and having a cylindrical member extended therefrom and engaged into the opening of the cover plate.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view of a lipstick making mold in accordance with the present invention;

FIG. 2 is a perspective view of the device, in which a portion of the mold is cut off;

FIG. 3 is a cross sectional view taken along lines 3-3 of FIG. 4;

FIG. 4 is a cross sectional view taken along lines 4-4 of FIG. 3;

FIG. 5 is a cross sectional view taken along lines 5-5 of FIG. 6;

FIG. 6 is a cross sectional view taken along lines 6-6 of FIG. 5; and

FIGS. 7 and 8 are perspective views showing the lipsticks made by the lipstick making mold in accordance with the present invention.

### DETAILED DESCRIPTION OF THE PREFERRED EMBODIMENT

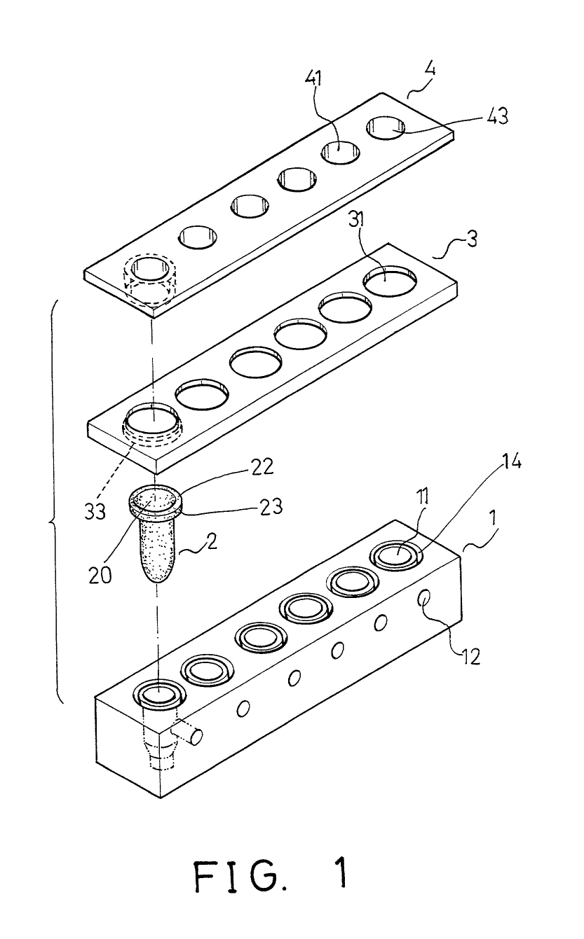

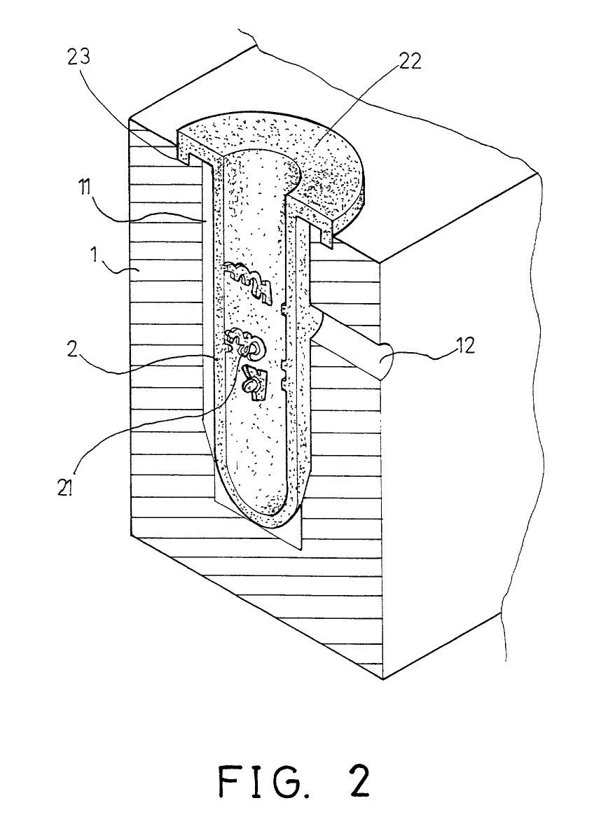

Referring to the drawings, and initially to FIGS. 1-4, a lipstick making device in accordance with the present invention comprises a base 1 including one or more cavities 11 formed therein and including one or more orifices 12 laterally formed therein and communicating with the cavities 11 thereof, and including one or more peripheral grooves 14 formed in the upper portion thereof and formed around the cavities 11 respectively.

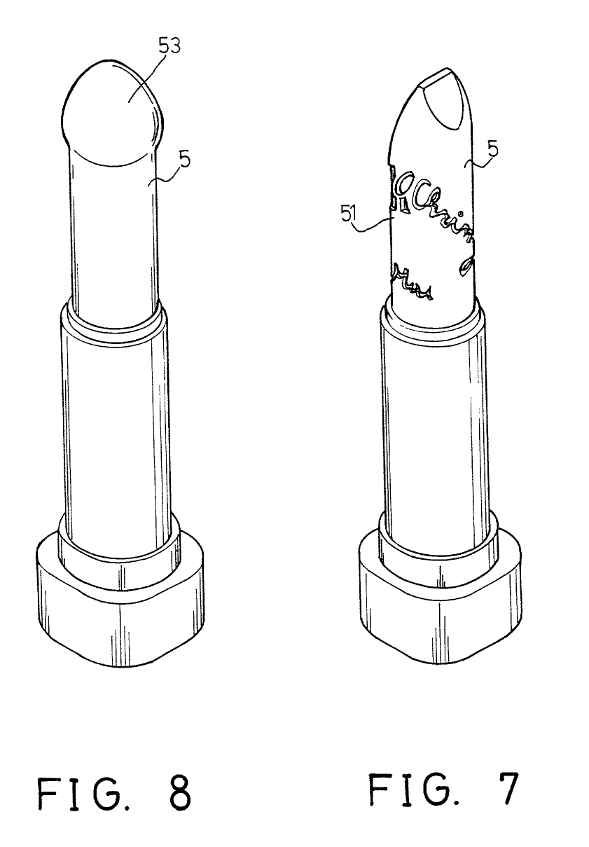

One or more elastic mold pieces 2 are received in the cavities 11 of the base 1 respectively and are preferably made of resilient or elastic rubber or plastic materials, for allowing the elastic mold pieces 2 to be suitably expanded. The elastic mold pieces 2 each includes a chamber 20 formed therein for receiving the lipstick material 5 or the material for forming the lipstick 5, and each includes a projection or a word or a pattern 21 extended inward of the chamber 20 thereof for forming the pattern 51 (FIG. 7) or the pattern 53 (FIG. 8) in the lipstick material 5. The elastic mold pieces 2 each includes an upper portion having a peripheral flange 22 extended radially outward therefrom and having a peripheral skirt 23 extended or dependent downward from the outer peripheral portion of the peripheral flange 22 and engaged in the peripheral grooves 14 of the base 1, such that the elastic mold pieces 2 may be stably secured to the base 1 and may be stably retained in the cavities 11 of the base 1.

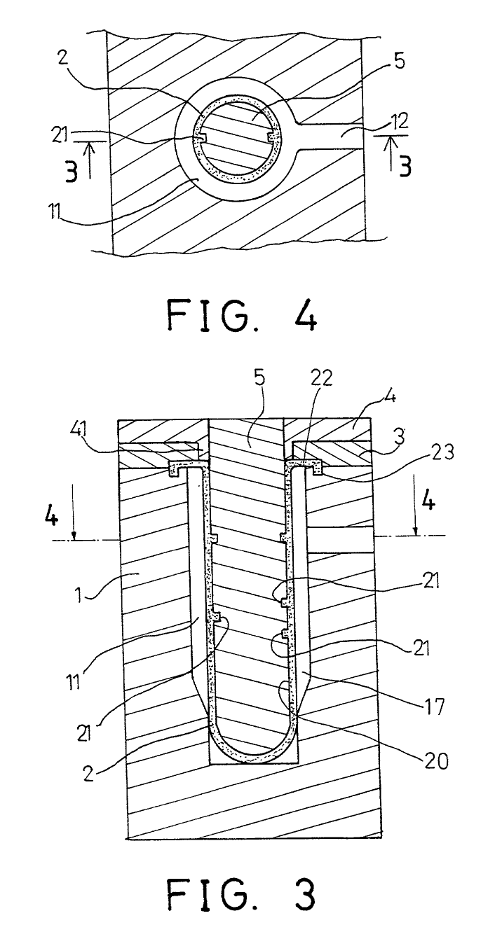

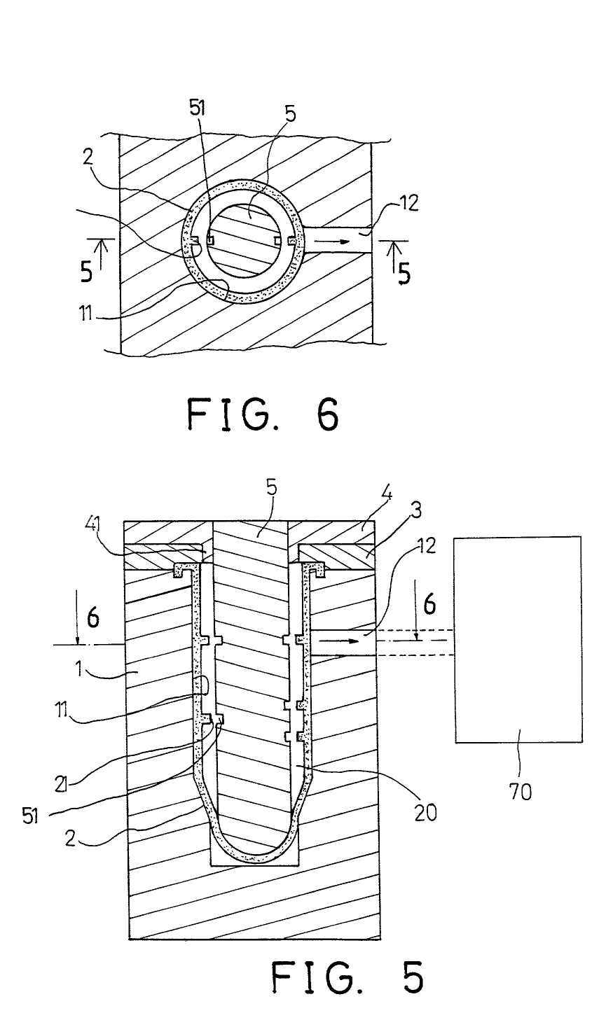

A cover plate 3 is engaged on the base 1 and includes one or more openings 31 formed therein and aligned with the cavities 11 of the base 1 and includes one or more peripheral depressions 33 formed around the openings 31 of the cover plate 3 respectively for receiving the peripheral flanges 22 of the elastic mold pieces 2 and for clamping and retaining the peripheral flanges 22 of the elastic mold pieces 2 between the base 1 and the cover plate 3. The openings 31 of the cover plate 3 include an inner diameter greater than the inner diameter of the chamber 20 of the elastic mold piece 2, best shown in FIGS. 3, 5.

A cover board 4 is further provided and engaged on top of the cover plate 3 and includes one or more cylindrical members 41 extended downward therefrom for engaging into the openings 31 of the cover plate 3 and for forming or defining an aperture 43 in each of the cylindrical members 41. The apertures 43 of the cover board 4 includes an inner diameter equal to the inner diameter of the chamber 20 of the elastic mold piece 2, best shown in FIG. 3, before the elastic mold piece 2 is expanded. The chamber 20 of the elastic mold piece 2 and the aperture 43 of the cover board 4 may thus be used for receiving the lipstick material 5 and for forming the lipstick. The cover plate 3 and the cover board 4 may be formed as an integral one-piece member, instead of two separated members. The cover plate 3 and the cover board 4 may be clamped and secured to the base 1 with the clamping devices or the hydraulic or pneumatic cylinders.

As best shown in FIGS. 3-6, the cavities 11 of the base 1 has an inner diameter greater than the outer diameter of the elastic mold pieces 2, such that a peripheral gap 17 may be formed between the elastic mold piece 2 and the base 1 (FIG. 5) and such that the elastic mold pieces 2 may be suitably expanded (FIGS. 5, 6). As shown in FIG. 5, a vacuuming device 70, such as a vacuum pump, is provided and coupled to either or all of the orifices 12 of the base 1 for vacuuming the peripheral gaps 17 formed between the elastic mold pieces 2 and the base 1. The elastic mold pieces 2 may thus be sucked or drawn to engage with the base 1, for allowing the lipstick material 5 to be easily removed from the base 1 and the elastic mold pieces 2 after the lipstick material 5 is cured or formed or hardened. When the elastic mold pieces 2 are sucked or drawn to engage with the base 1 as shown in FIG. 5, the cover plate 3 and the cover board 4 may be removed or separated from the base 1 and will not affect or spoil the drawn or the attachment of the elastic mold pieces 2 to the base 1.

Accordingly, the lipstick making mold in accordance with the present invention includes a vacuuming device for easily and quickly removing the lipstick from the mold piece.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A lipstick making device comprising:
a base including at least one cavity formed therein,
at least one elastic mold piece received in said at least one cavity of said base for receiving a lipstick material, said at least one elastic mold piece including an outer diameter smaller than an inner diameter of said at least one cavity of said base, for defining a peripheral gap between said at least one elastic mold piece and said base, and
means for vacuuming said peripheral gap formed between said at least one elastic mold piece and said base to draw said at least one elastic mold piece to engage with said base and to facilitate a disengagement of the lipstick material from said at least one elastic mold piece.

2. The lipstick making device according to claim 1, wherein said base includes at least one orifice formed therein and communicating with said peripheral gap and said at least one cavity of said base, said vacuuming means includes a vacuuming device coupled to said at least one orifice of said base to vacuum said peripheral gap and said at least one cavity of said base.

3. The lipstick making device according to claim 1, wherein said base includes at least one peripheral groove formed around said at least one cavity of said base, said at least one elastic mold piece includes a peripheral flange extended radially outward therefrom and a peripheral skirt extended from an outer peripheral portion of said peripheral flange and engaged in said at least one peripheral groove of said base.

4. The lipstick making device according to claim 1, wherein said at least one elastic mold piece includes a peripheral flange extended radially outward therefrom, said lipstick making device further includes means for securing said peripheral flange of said at least one elastic mold piece to said base.

5. The lipstick making device according to claim 4, wherein said securing means includes a cover plate engaged on said peripheral flange of said at least one elastic mold piece and said base.

6. The lipstick making device according to claim 5, wherein said cover plate includes a peripheral depression formed therein for receiving said peripheral flange of said at least one elastic mold piece.

7. The lipstick making device according to claim 5, wherein said cover plate includes at least one opening formed therein, said securing means includes a cover board engaged on said cover plate and having a cylindrical member extended therefrom and engaged into said at least one opening of said cover plate.
